(19) United States
(12) Patent Application Publication
(10) Pub. No.: US 2012/0325842 A1
(43) Pub. Date: Dec. 27, 2012

(54) Pizza Box Stacker, Carrier and Dispenser

(76) Inventor: Rusty A. Restaino, Yonkers, NY (US)

(21) Appl. No.: 13/213,861

(22) Filed: Aug. 19, 2011

Related U.S. Application Data
(63) Continuation-in-part of application No. 13/166,154, filed on Jun. 22, 2011.

(51) Int. Cl. B65G 59/06; B65D 83/00

(52) U.S. Cl. 221/282

(57) ABSTRACT

A stacker, dispenser, and carrier in the form of a container for pizza boxes has a rectangular parallelepiped formed with a front opening for withdrawing boxes, a front support and a rear support on which the boxes are rested and a fulcrum for tilting the lowermost box to separate it from the box immediately above for reducing friction as the lowermost box is withdrawn. In one embodiment, the container has a rear opening for sliding the lowermost box off the front support as it is pushed rearward through the opening, the rear support serving as a fulcrum for lowering the front of the box which can then be withdrawn through the front opening of the container. In another embodiment, the container has a ramp in the rear for urging the lowermost box onto the rear support and partially extended through the opening in the container. Here the front support serves as a fulcrum for lowering the front of the box which can then be withdrawn through the front opening of the container.

### BACKGROUND OF THE INVENTION

It is a common sight at pizzerias to see pizza boxes stacked on a counter in a work area near a pizza oven. Before removing a pizza from the oven, the pizza man withdraws a box from the stack, opens it up, and then places a hot pizza inside the box.

As many as 40 or more boxes may be placed on a stack. Pulling one out from or near the bottom of the stack can be difficult in that the weight of the boxes on top of the one being withdrawn causes substantial friction between the upper surface of the box to be withdrawn and lower surface of the box above it. Moreover, as boxes are withdrawn the stack can be jostled resulting in the stack becoming misaligned and possibly falling over.

Various attempts to facilitate the removal of pizza boxes from a stack have resulted in apparatuses which are complicated and expensive to construct and/or which do not solve the problem of reducing friction between the boxes. For example, U.S. Patent Application Publication No. 2008/0224577 by Whitty for an Apparatus for Storing and Dispensing a Plurality of Boxes discloses a rectangular cage which is open at the top to receive pizza boxes to be stacked on the floor of the dispenser. A stack of boxes may also be inserted by opening a front door of the cage which has a bottom that is raised from the floor of the cage to provide a slot through which pizza boxes can be removed by pulling them forward. An optional guide wall at the bottom of the dispenser urges the boxes forward through the slot.

U.S. Pat. No. 4,037,756 to Jaquish for a Display-Dispenser Rack and U.S. Pat. No. 5,447,253 to Williams for a Condom Dispenser also show ramps or guide walls at the bottom of dispensers.

U.S. Pat. No. 5,328,258 to Scalise for a Pizza Box Storage and Dispensing Assembly describes a rectangular stacker with two telescoping sections for varying the height of the device. Springs are used to grasp the pizza boxes and keep their weight off of the bottom box so that it can be easily withdrawn. Vertical corner sections project inwardly to prevent all but the lowermost of the boxes from moving forwardly and extend short of the bottom of the assembly for providing a widened slot through which the lowermost box can be removed. The height of the stack can be determined by viewing the boxes through the opening between the corner sections. A downwardly inclined plate facilitates removal of the boxes through the slot.

A basic dispenser for flat rectangular boxes which are pulled from the bottom of a stack through a horizontal opening is the subject of U.S. Pat. No. 1,986,101 to Brodsky. Brodsky teaches that the dispenser can be made by folding a sheet of cardboard having score lines to define the panels of the dispenser.

U.S. Patent Application Publication No. 2004/0188365 by Forte discloses a stacker that can handle a single stack of pizza boxes or multiple stacks side-by-side. The device has rear and side walls with an open front for containing the boxes while permitting the height of the stack to be viewed. There is an enlarged horizontal opening at the bottom for enabling withdrawal of the lowermost box from the stack.

U.S. Pat. No. 3,301,388 to Rockwell discloses a Playing Card Dispenser having a stand or frame for supporting a rectangular cartridge filled with boxes of playing cards. The cartridge has a delivery opening at its bottom for removing the lowest box in the stack. The side walls are notched to allow the box to be grasped. Rockwell also teaches that his dispenser can be made by folding a sheet of cardboard having score lines to define the panels of the dispenser.

U.S. Pat. No. 4,769,573 to Celik for a Tape Cassette Dispenser features a transparent rectangular enclosure with a horizontal inwardly notched slot at the bottom of the front wall through which the lowest tape cassette in a stack can be extracted. A similar tape dispenser is disclosed in U.S. Pat. No. 5,515,999 to Jo for an Audio Cassette Displayer and Dispenser.

U.S. Pat. No. 4,597,614 to Alexander for a Storage Dispenser Rack for Rectangular Articles discloses a container with multiple openings at differing heights through which stacked video cassettes and other rectangular articles can be withdrawn.

None of the above patents discloses a dispenser as simple and cost effective as the one of the present invention. In addition to being used as a stacker and dispenser, the container of the present invention also serves as a carrier. When formed from a lightweight material such as corrugated cardboard, one of the panels of the container can be grasped in one hand at the top and carried from one place to another while front and rear supports keep the pizza boxes securely within the container.

### SUMMARY OF THE INVENTION

A container for facilitating removal of the lowermost box from a stack of boxes has the general form of a hollow parallelepiped with a front panel, a rear panel, a left side panel and a right side panel. The front panel has proximate a bottom end of the container a lower opening with a width greater than the width of one of the boxes. There are at least one front support and one rear support mounted inside the container proximate the front panel and rear panel, respectively, upon which a bottom area of a lowermost one of the stack may be rested. A magnet and a ferromagnetic strip can be mounted along adjacent ones of the panels for reversibly securing them.

One of the front and rear supports is a fulcrum about which the lowermost box may be rotated by lowering its front end thereby pivoting the rear end upwardly for reducing the area of contact and friction with the box immediately above.

In a first preferred embodiment of the invention the front and rear supports are mounted below and opening in the rear wall of the container through which the rear end of the lowermost box in the stack may be passed for clearing the front support and tilting the box downwardly and away from the stack for pulling it through the lower opening.

In a second preferred embodiment of the invention the front support and rear supports may be in the form of rods with ends mounted in the side panels of the container and rollers spaced along the rods. A ramp on the rear panel urges the lowermost one the boxes forward through the lower opening. The distance between the top of the front support and the top of the lower opening is greater than the height of one of said boxes but less than twice the height of one of the boxes so that only the lowermost one of the boxes can be pulled through the container opening.

### DESCRIPTION OF THE DRAWINGS

FIG. 1 is a perspective view of a filled pizza box stacker, dispenser and carrier in accordance with a first preferred embodiment of the invention.

FIG. 2 is a rear elevation view of the apparatus of FIG. 1.

FIG. 3 is a top plan view of the apparatus of FIG. 1 in an empty state.

FIG. 4 is a side sectional elevation view of the apparatus of the invention taken through line 4,5-4,5 of FIG. 2.

FIG. 5 is a side sectional elevation view of the apparatus of the invention as shown in FIG. 4 in a later stage of use.

FIG. 6 is a perspective view of the apparatus of the invention in a later stage of use than that shown in FIG. 5.

FIG. 7 is a sectional side elevation view of the apparatus of the invention in a still later stage than that shown in FIG. 6.

FIG. 8 is a plan view of a sheet of material from which the first preferred embodiment of the invention can be assembled.

FIG. 9 is a partial perspective view showing a portion of the first preferred embodiment of the invention.

FIG. 10 is a partial perspective view showing a portion of a first modification to the first preferred embodiment of the invention.

FIG. 11 is a partial perspective view showing a portion of a second modification to the first preferred embodiment of the invention.

FIG. 12 is an elevation view of a second alternate preferred embodiment of the invention prior to assembly.

FIG. 13 is a front elevation view of the second preferred embodiment of the invention with front panel removed.

FIG. 14 is a side elevation view of the second preferred embodiment of the invention with right side panel removed in a first stage of use.

FIG. 15 is a side elevation view of the second preferred embodiment of the invention with right side panel removed in a second stage of use.

### DESCRIPTION OF THE PREFERRED EMBODIMENTS

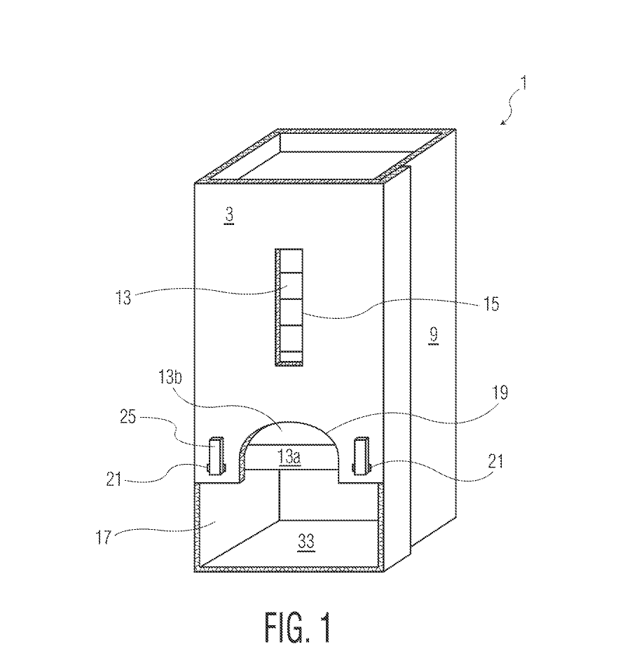

Referring now to FIGS. 1-3 of the drawings there is shown a container 1, for serving as a pizza box stacker dispenser and carrier, in the general form of a hollow upright rectangular parallelepiped having a front panel 3, a rear panel 5, a left side panel 7 and a right side panel 9. The container 1 has an open top 11 through which a stack of conventional pizza boxes 13 may be inserted to form a stack. Although described for use in storing, carrying, and dispensing pizza boxes, the present invention is applicable generally to storing, carrying, and dispensing other types of boxes or other uniformly sized rectangular objects preferably having a low profile.

On the front panel 3 of the container 1 there is a centered vertical slot 15 forming a window in the panel 3 through which a portion of the stack of boxes can be seen. The window 15 provides a view from which it can be determined when it is necessary to refill the container 1 with more pizza boxes after a sufficient number have been withdrawn from the bottom of the container 1 as hereinafter explained.

At the bottom of the container 1 there is a rectangular lower opening 17 having a width slightly larger than the width of the pizza boxes intended to be stored within the container 1 and dispensed from it. Continuous with the opening 17 at the bottom of the container 1 is an upper opening 19 having a width narrower than the width of the pizza boxes 13.

The opening 19 is wide enough to enable the lowermost pizza box 13a in the container 1 to be grasped, preferably with the thumb of one hand pressing against the front edge of the box and the fingers of the same hand touching the box from below. The opening 19 preferably has a rounded top to form an arch for structural integrity and an aesthetically pleasing appearance.

On each side of the opening 19 there is inserted through a horizontal slot 21 in the front panel 3 of the container 1, a right angle bracket 25 serving as a support for the bottom of the lowermost pizza box 13a in an area proximate the front panel 3 of the container 1. Although shown as mounted on the front panel 3 of the container 1, the supports 25 can be mounted on the inside surfaces of the left side panel 7 and right side panel 9 adjacent the inside surface of the front panel 3.

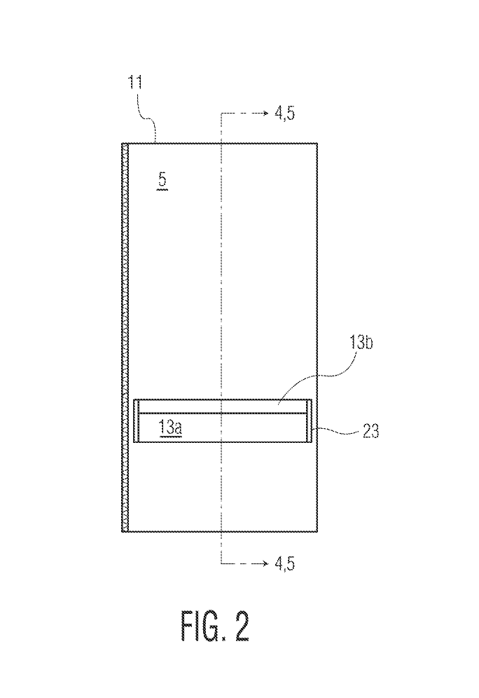

Referring now to FIG. 2 of the drawings there is shown the rear panel 5 of the container 1. Cut into the rear panel 5 of the container 1 is a rectangular opening 23 having a width slightly larger than the width of the boxes 13 and a height greater than the height of a single box 13 but less than twice the height of a box 13. Hence one box 13, and only one box 13, may be received within the rear opening 23 at a time.

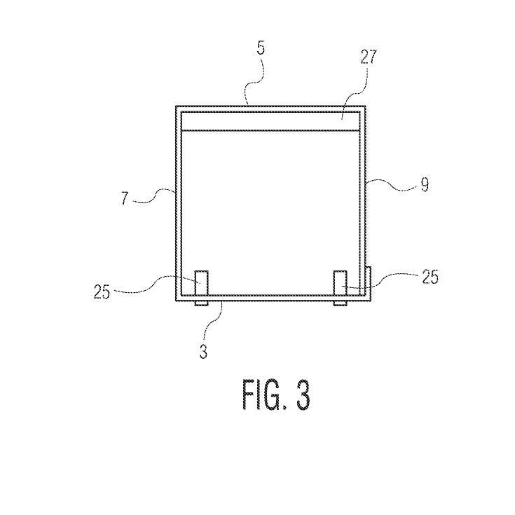

Referring to FIG. 3 of the drawings, looking down into the container 1, there can be seen the horizontal surfaces of front supports 25 formed by brackets which support the bottom of the lowermost pizza box in the stack of boxes 13 housed within the container 1, and a horizontal ledge of a rear support 27 beneath the rear opening 19. The uppermost surface of the rear support ledge, the uppermost surfaces of the horizontal portions of the brackets 25, and the bottom of the rectangular opening 23 are in the same horizontal plane, i.e., transverse to the panels 3, 5, 7 and 9.

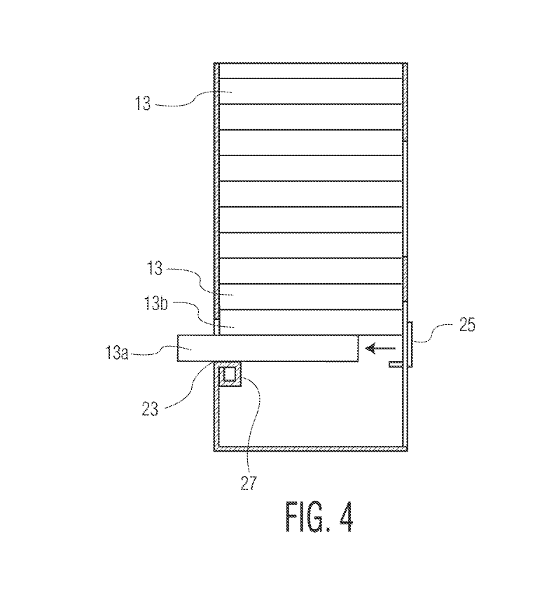

Referring now to FIG. 4 of the drawings there is shown a stack of pizza boxes 13 within a container 1 from which the lowermost box 13a is to be removed. As can be seen in FIG. 4, the lowermost box 13a has been pushed, by inserting pressure on its front panel, exposed in the upper opening 19 of the container 1, toward the rear of the container 1 thereby causing the lowermost box 13a to partially pass through the rectangular opening 23 to a position at which the front of the lowermost box 13a has cleared and is rearward of the supports 25 on which it was resting.

During movement through the rear slot, the lowermost box 13a remains supported by the rear support 27. At this time the area of the top surface of the lowermost box 13a within the container 1 continues to engage the bottom surface of the box 13b immediately above it, with the weight of the stack of boxes 13 causing friction between the lowermost box 13a being dispensed and the box 13b above it.

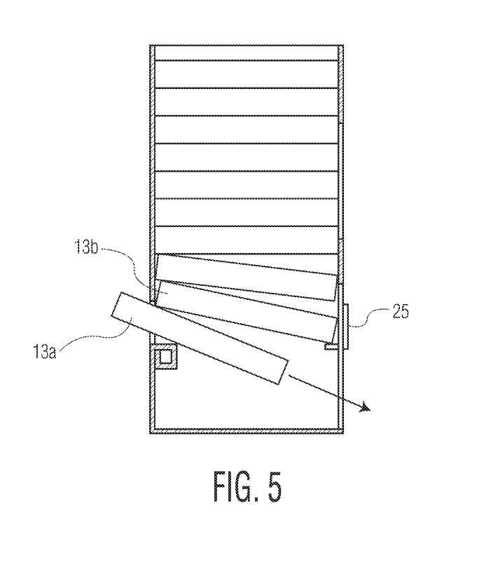

Referring now to FIG. 5, as soon as the lowermost box 13a clears the bracket 25, it may be tilted downward about a fulcrum formed by the rear support 27 in a direction so that the box is aimed at the bottom opening 17 in the container 1. As the lowermost box 13a is tilted downward, it disengages the box 13b above it except for a line of engagement along the bottom rear edge of the engaging box. This greatly reduces the amount of friction between the boxes 13a and 13b and the force which must be exerted on the lowermost box 13a to withdraw it from the container 1 below the force that would have to be exerted if the lowermost box 13a were withdrawn while its entire surface area within the container 1 was in engagement with the bottom surface of the box 13b immediately above it.

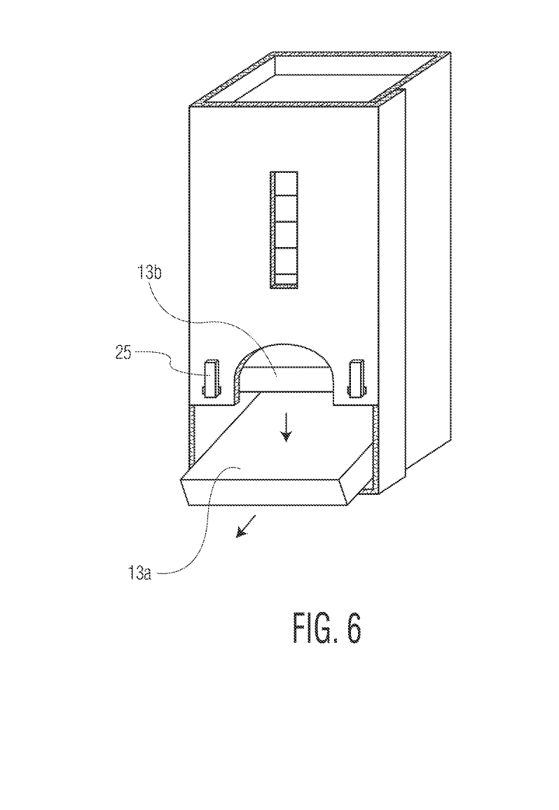

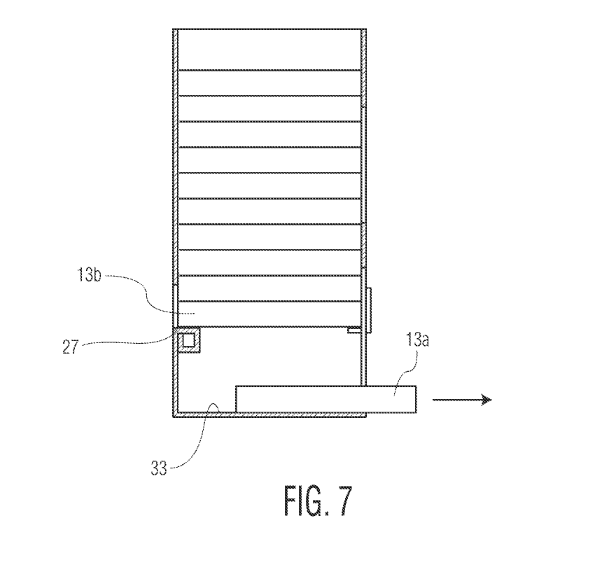

As can further be seen in FIG. 5, as the lowermost box 13a is tilted downward, having cleared the bracket 25, the box 13b immediately above it also tilts downward until its front lands on the horizontal portion of the bracket 25. The bracket 25 prevents the box 13b from falling any further. Referring to FIGS. 6 and 7, as the downward tilted lowermost box 13a is pulled from the dispenser its rear edge clears the rear support 27 and drops to the floor 33 of the container 1. At this time, the next to lowermost box 13b drops down onto the rear support and assumes a horizontal disposition as do all of the boxes above it. The lowermost box 13a is now free of all friction from the box above it and can be easily withdrawn from the container 1.

The floor 33 of the container 1 is optional and not necessary to its dispensing function. However, the floor 33 provides a smooth surface for withdrawing the box to be dispensed with little friction and also enhances the rigidity of the container 1. Another benefit of the floor 33 is that it protects the boxes 13 from the surface of the countertop on which the container 1 is placed including any debris which may be present on the countertop.

In order to provide ample room for the lowermost box 13a to be momentarily pushed rearwardly through the opening 23, the container 1 should be spaced from the wall behind it. This can be done by placing a spacer (not shown) on the top of the counter on which the container 1 is mounted between the rear panel 5 of the container 1 and the wall behind it.

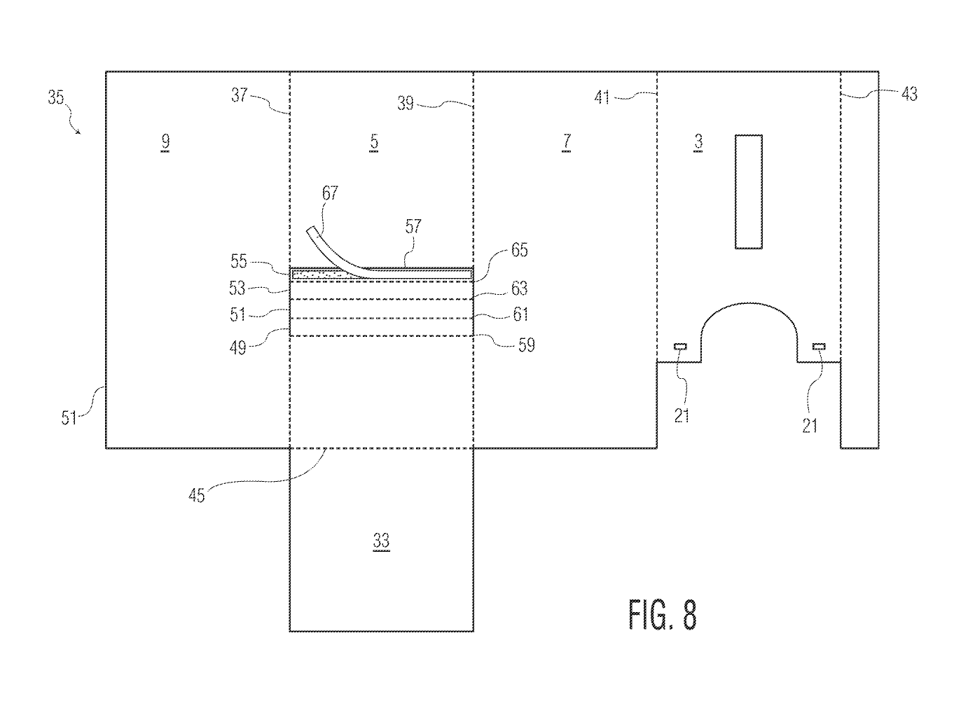

Referring now to FIG. 8 therein shown a sheet of corrugated cardboard or like semi-rigid stock from which the container 1 can be assembled. The sheet 35 has a top edge and a bottom edge and is scored to form parallel fold lines 37, 39, 41, 43 extending from the top edge to the bottom edge. Fold line 37 is between right side panel 9 and rear panel 5. Fold line 39 is between left side panel 7 and rear panel 5. Fold line 41 is between left side panel 7 and front panel 3. A fold line 45 transverse to the lines 37, 39, 41, 43 separates the bottom panel 33 from the rear panel 5. It is not necessary that the optional bottom panel 33 be attached to the rear panel 5, and it may be similarly connected to either of the side panels 5, 7 and 9. Also, the order of the panels on the sheet 35 can be changed by rotating them in either direction. For example, the front panel 3 can be between fold lines 37 and 39 in which case the right side panel 9 would be between fold lines 39 and 41.

The container 1 is assembled by folding the bottom panel 33 along score line 45 rearwardly and upwardly until it is horizontal. The right side panel 9 is folded rearwardly along score line 37 until it is in a plane perpendicular to the plane of rear panel 5.

The rear panel 5 is folded along score line 39 until it is in a plane perpendicular to the plane of the left side panel 7. At this time right side panel 9 is parallel to left side panel 7. Front panel 3 is folded along score line 41 until it is perpendicular to sides panels 7 and 9 and parallel to rear panel 5. The exposed vertical edge 51 of the right side panel 9 is abutted against the inside surface of front panel 3 just inside the score line 43.

A fastener panel 47 is then folded back along the score line 43 until its inside surface engages the outside surface of the right side panel 9. Fastener panel 47 should always be at the one end of the sheet 35 so that it may be folded over and affixed to an adjacent panel.

The inside surface of the fastener panel 47 preferably has an adhesive coating which can be moistened to adhere it to the right side panel 9. More conveniently, the adhesive may be a pressure sensitive adhesive which employs a peel-off strip that can be removed to expose the tacky surface of the adhesive for joining the fastener panel 47 to the right side panel 9.

As can be seen in FIG. 4, the horizontal rear support 27 is provided by cutting and inwardly folding upon itself a portion of the rear panel 5 of the container 1. Referring to FIGS. 4 and 8, a hollow rectangular parallelepiped having a square cross section is formed by punching out a flap scored for forming fold lines between horizontal folds 49, 51, 53 and 55. To enable this there is a cut through the sheet 35 along line 57 and along the score lines 37 and 39 extending from cut line 57 to score line 59 which is immediately below fold 49. In addition to score line 59, score lines 61, 63 and 65 are formed below and parallel to cut line 39.

The flap is folded about score line 59 so that the fold 49 is in a horizontal plane with its uppermost surface atop the rear support 27 upon which a box 13 will rest. The flap is further folded along score line 61 so that fold 51 is in a plane parallel to the rear panel 5 of the container 1. The flap is further folded along score line 63 for placing fold 53 at the bottom of the rear support 27 and in a plane parallel to the floor 33 of the container 1. Finally, the flap is folded along score line 65 to enable fold 55 to be rotated upwardly into a plane parallel to the rear panel 5 of the container 1.

Preferably the fold 55 is slightly narrower than the folds 49, 51, and 53 which are of equal height, for enabling the uppermost edge of the fold 55 to engage the underside of the fold 49 while maintaining a square disposition for the rear support 27.

Fold 55 may be coated with an adhesive and covered with a peel away strip 67 which can be removed once the folds are completed to enable the fold 55 to be urged against the inside surface of the panel 5 for adhering fold to the panel 5 so that the rear support 27 does not unravel. This provides a strong and stable horizontal platform upon which the rear of the lowermost box 13a can rest during normal storage and along which it can be slid as it is pushed rearwardly prior to removable from the stack.

The brackets 25 may be right angle brackets made from any rigid material including metal or plastic. For maximum strength, the brackets 25 can be inserted through horizontal slots 21 scored into the front panel 3 of the container 1.

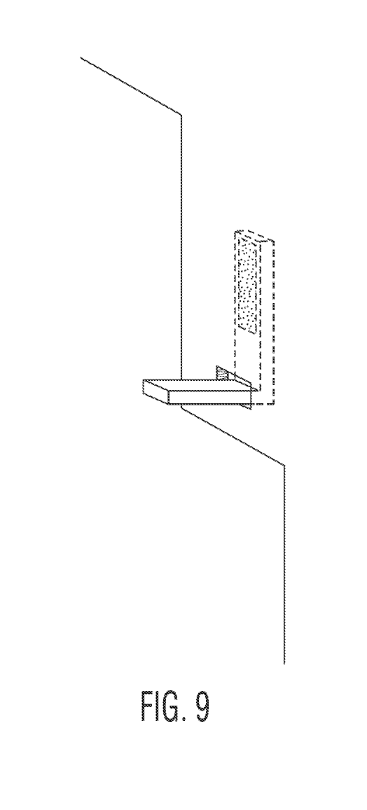

Referring additionally to FIG. 9, the inside surfaces of the vertical arms of the angle brackets 25 facing the outer surface of the front panel 3 can be coated with a pressure-sensitive adhesive covered by a peel away strip and pressed against, and thereby affixed to, the front panel 3. The horizontal arm of each angle bracket 25 rests on, and is supported by, the exposed inside edge of its respective slot 21 for stability and strength.

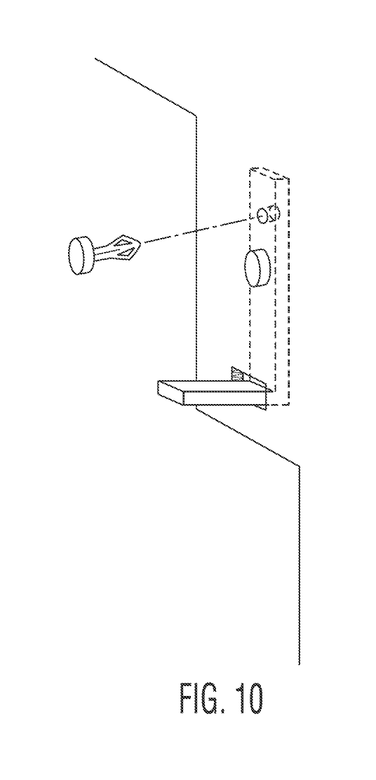

Alternatively, as shown in FIG. 10, the vertical arm of the bracket 25 can be apertured for receiving an expandable push pin fastener that can be inserted through the front panel 3 and the vertical arm from either side. Other types of conventional fasteners may employed as will be known to those skilled in the art. It is important that the portion of the fastener that extends into the interior of the container 1 not penetrate deeply enough to interfere with the downward movement of the stack of pizza boxes as each lowermost box 13a is withdrawn.

In instances where an adhesive used to affix the brackets forming the supports 25, and the panel on which the brackets are mounted are strong enough to withstand shearing forces on the inside surfaces of the container 1 due to the weight of the stacked boxes 13, the rear surfaces of the vertical arms of the brackets 25 can be adhered to the inside surface of the front panel 3 of the container 1 without forming, or inserting the brackets through, slots in the front panel 3 of the container 1. Here too a peel off strip can be used to expose an adhesive on the rear of the brackets' vertical arms which can then be pressed against the inside facing surface of the front panel 3.

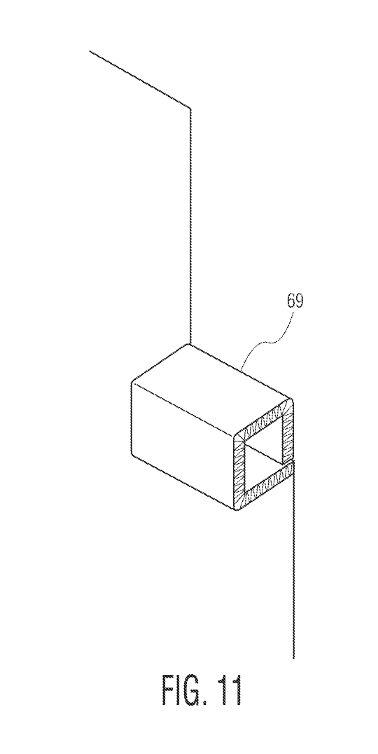

Referring now to FIG. 11 it can be seen that the vertical brackets 25 may be replaced with folded over flaps 69 scored into and punched from the front panel 3 at appropriate heights so that the top surface of each front support 69 is level with the rear support 27. Each front support 69 can be formed in a manner similar to that in which the rear support 27 is formed. That is, scored into the front panel at each side of the opening 19 can be a vertical flap having four sections, the lowermost three sections being of equal height and the uppermost one being slightly shorter so that when folded the vertical flap will form an open rectangular parallelepiped 69 as shown in FIG. 11 with the face of the front support 69 adjacent to the inside surface of the front panel 3 adhered to it with an adhesive.

Just as the angle brackets in the front of the container 1 can be replaced with an integral folded flap to form front supports, so too can the rear support 27 heretofore described as being formed from an integral flap 5 in the rear panel 5 of the container 1, be replaced with a plastic or metal bracket having a flat horizontal surface. The rear support 27 can have an L shaped cross section and be inserted through an elongated horizontal slot in rear panel 5 of the container 1 with its vertical member fastened to the outside of rear panel 5 by an adhesive or one or more mechanical fasteners. Alternatively, the vertical member of the L-shaped bracket can be fastened to the inside of rear panel 5 by an adhesive or one or more mechanical fasteners.

It is to be noted that the front supports 25 can be affixed not only to the front panel of the container 1 but also to the inside surfaces of the side panels 7, 9 of the container 1 at positions adjacent to the front panel 3.

It is desirable that the inner dimensions of the container 1, that is the length and width, be only slightly larger than the length and width of the pizza boxes to be stored in and dispensed from the container 1. In order to prevent jamming of the pizza boxes within the container 1, it is preferable to have each of the length and width of the inside of the container 1 exceed the outside length and width of the pizza boxes by ⅛ to one ¼ inch. The sum of the distances by which the front supports 25, on the one hand, and the rear support 27, on the other hand, extend toward one another should be greater than the distance by which the depth of the inside of the container 1 exceeds the depth D of the pizza boxes 13.

For a pizza box having a width W a depth D and a height H, the interior width of the container 1 is preferably in the range of W+⅛ inch to W+¼ inch. In the preferred embodiment of the invention, the preferred depth of the horizontal platforms of the front and rear supports are preferably each between ½ inch and 1 inch.

In lieu of the elongated rear support 27 disposed beneath the rear opening 19, one or more supports similar to the front supports 25 can be provided on rear panel 5 of container 1, or on side panels 7, 9 near rear panel 5. As in the case of rear support 27, the rear supports should have horizontal supporting surfaces coplanar with the horizontal supporting surfaces of the front supports 25.

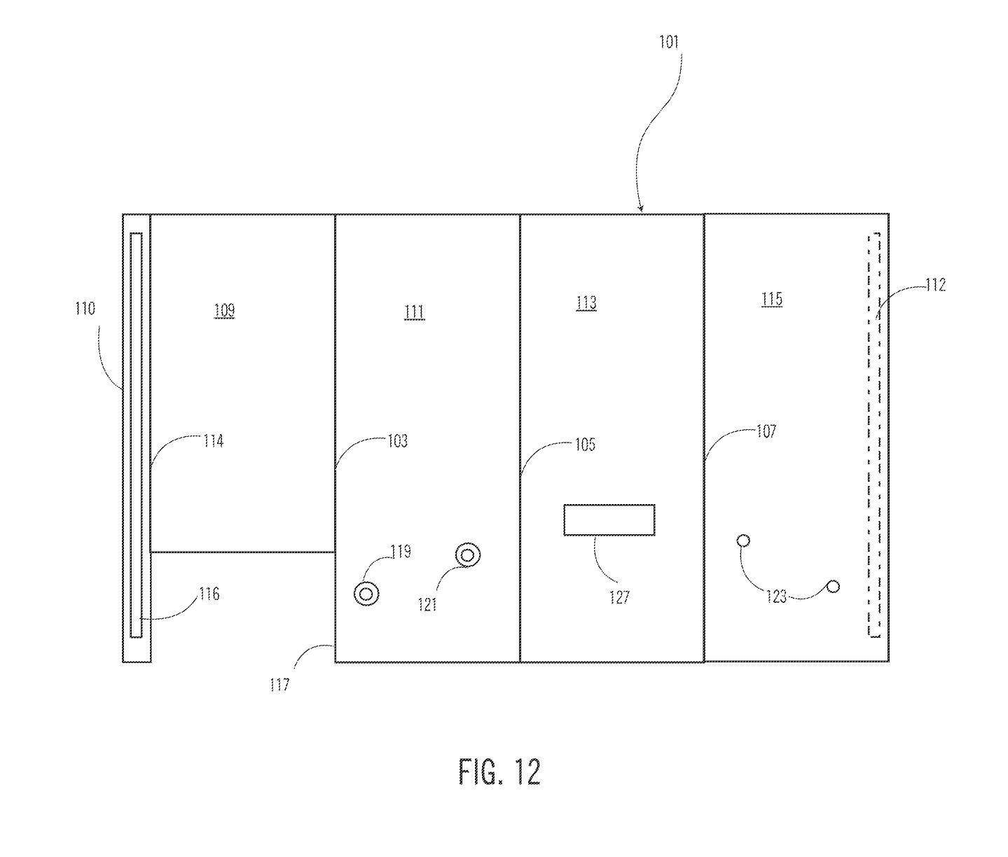

Referring now to FIG. 12 of the drawings there is shown a second preferred embodiment of the invention which can be assembled from a sheet 101 of rigid or semi-rigid stock, preferably of cardboard or plastic although other materials such as wood, chipboard, or metal can be used. The sheet 101, if continuous, can be scored along lines 103, 105, 107 to divide the sheet into a front panel 109, a left side panel 111, a rear panel 113, and a right side panel 115 of a container in the shape of a hollow rectangular paralleloped. In order to form the paralleloped, the panels can be folded about the score lines 103, 105, 107 which serve as hinges. Alternatively, the panels 109, 111, 113, and 115 can be separated and connected by mechanical hinges (not shown) as will be known to those skilled in the art.

The top of the front panel 109 is colinear with the tops of left side panel 111, rear panel 113, and right side panel 115 so that when the container is assembled the tops of all of the panels are at the same elevation. The bottom of the front panel 109 is raised above the bottoms of left side panel 111, rear panel 113, and right side panel 115 which are colinear so that when the container is assembled the bottoms of all of the panels form the bottom of the container and there is a lower opening 117 between the bottom of the container and the bottom of front panel 109.

Hinged to the edge of front panel 109 opposite the edge connected to left side panel 111 is an extension 110 having on its inside surface a vertical magnet 116 running substantially the full height of extension 110. Affixed to the outside surface of right side panel 115 adjacent its free edge, as shown in FIG. 12, is a strip of ferromagnetic material 112. When the container is assembled into a rectangular parallelepiped with the panel surfaces shown in FIG. 12 facing inward, the extension 110 can be bent around score line or hinge 114 into a plane transverse to the plane of front panel 109 and overlapping ferromagnetic strip 112.

The attractive force between magnet 116 and ferromagnetic strip 112 secures right side panel 115 to extension 110 completing the construction of a secure rectangular parallelepiped forming the container.

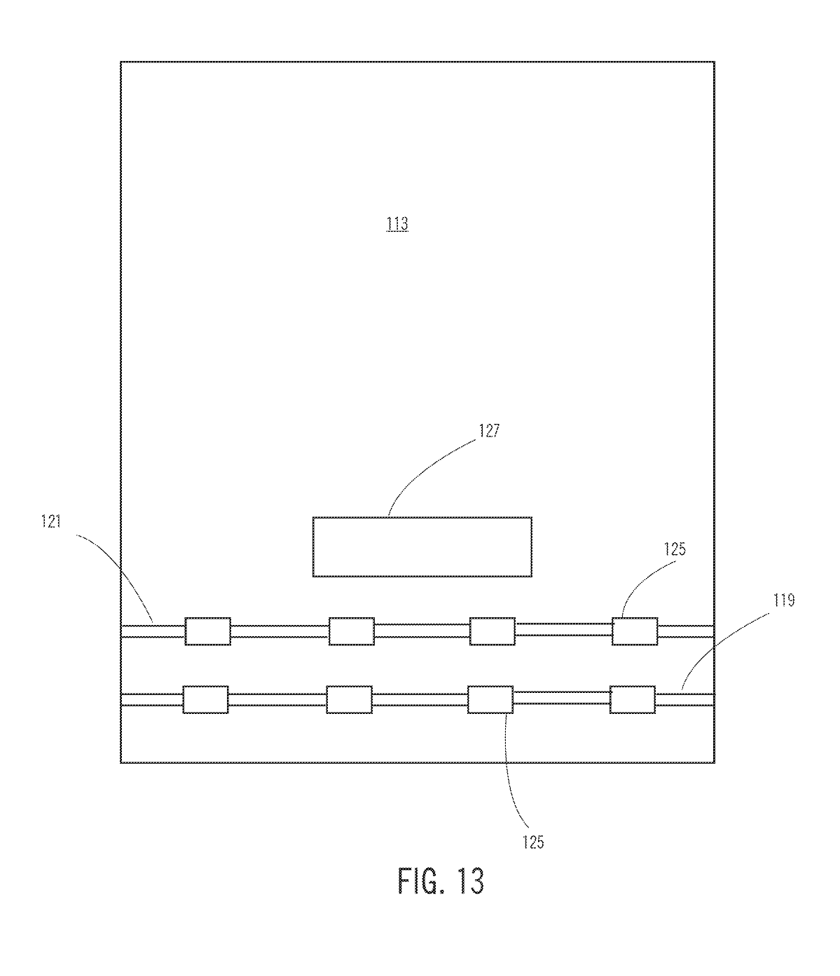

Referring additionally to FIG. 13, spanning the space between left side panel 111 and right side panel 115 are a front support 119 proximate front panel 109 and distal from rear panel 113 and a rear support 121 proximate rear panel 113 and distal from front panel 109, the supports 119, 121 being in the form of respective parallel cylindrical rods having opposite ends mounted in openings 123 in left side panel 111 and right side panel 115. Rod 119 is preferably mounted at least 3 inches above the bottom of the container so that it may conveniently serve as a fulcrum for tilting the front end of the lowermost box in the stack downwardly for withdrawing the lowermost box from the container.

Rear support rod 121 is preferably mounted at an elevation greater than that of front support rod 119, i.e., front support 119 is at an elevation nearer to the bottom of the container than rear support 121. The plane defined by the axes of front and rear support rods 119, 121 is preferably at an angle of 5 degrees to 30 degrees from horizontal when the container is in its normal upright position.

In order to minimize friction between the supports 119, 121 and the box being withdrawn from the container, rollers 125 are mounted on and spaced along the lengths of the rods 119, 121.

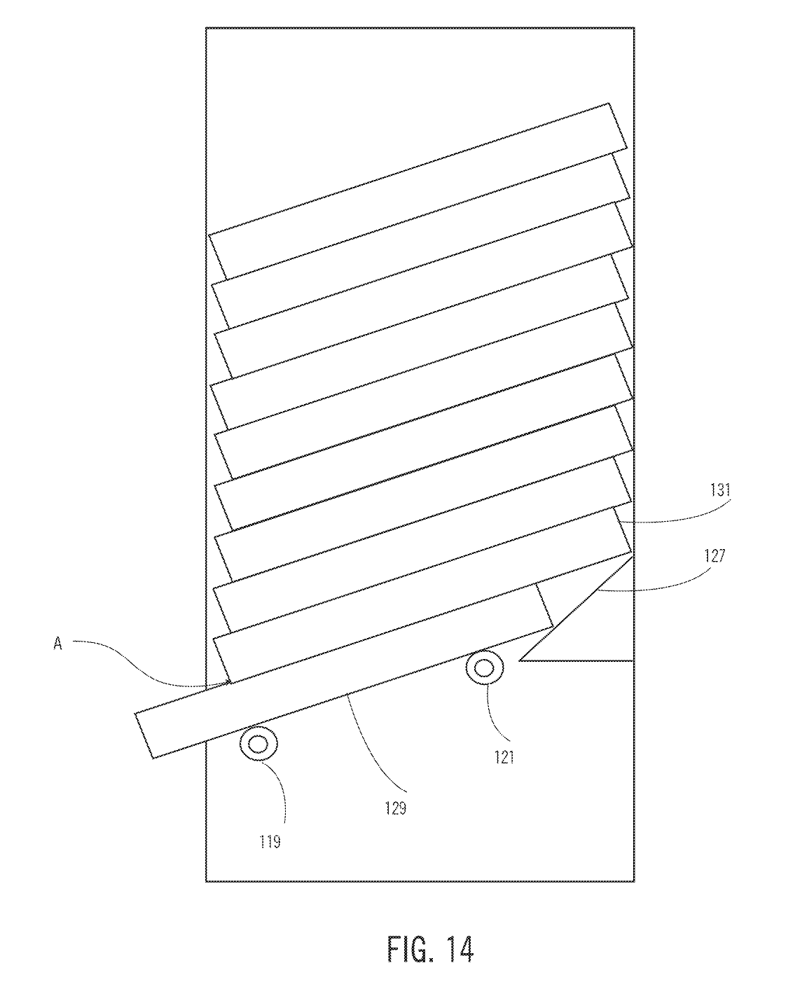

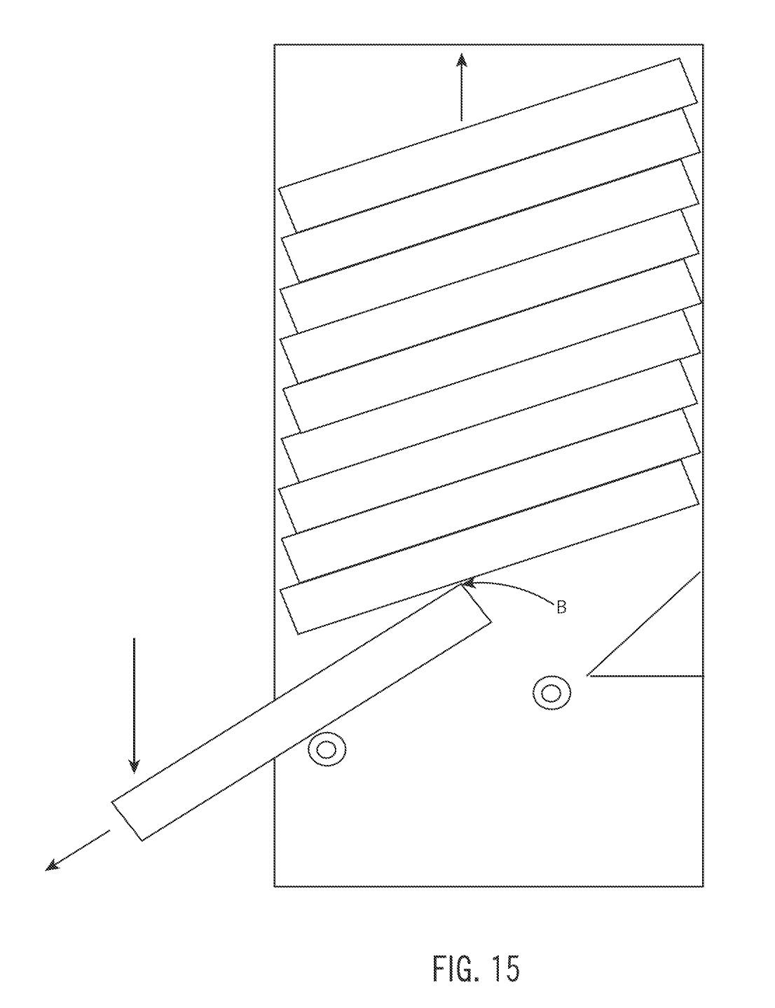

Referring further to FIGS. 14 and 15, there is mounted on the rear wall 113 of the container, behind rear support 121, a ramp 127 which slopes downwardly from its intersection with the rear wall 113 at an elevation above the rear support 121 toward rear support 121 for guiding the lowermost box onto rear support 121. That is, the uppermost end of ramp 127 is more distal from the bottom of the container than the rear support 121. The downward slope of ramp 127 is greater than the downward slope of the plane defined by the axes of the spaced parallel rods forming front support 119 and rear support 121. The ramp 127 is mounted proximate the rear panel at an elevation high enough for urging the lowermost one 129 of the stack of boxes in a forward direction for extending the front end of that box through the lower opening, and an elevation low enough to prevent engagement of box 131 immediately above lowermost box 129 with ramp 127.

As can be seen in FIG. 14, the lowermost box 129 in a stack of boxes has been urged by its own weight and the weight of the stack of boxes above it downwardly against the ramp 127 which in turn urges the lowermost box forward until the rear portion of lowermost box 129 comes to rest on rear support 121 and the front portion of lowermost box 129 extends forward through lower opening 117 of the container. Friction at the interface A between the top of lowermost box 129 and the bottom of box 131 immediately above lowermost box 129 prevents further forward movement of lowermost box 129 and provides resistance which must be overcome in order to pull lowermost box 129 from the container for use.

The height of the lower opening 117 in front panel 109 is great enough to enable lowermost box 129 to pass between front support 119 and the uppermost edge of lower opening 117 and low enough to cause front panel 109 to act as a barrier for preventing box 131 immediately above lowermost box 129, and all of the other boxes in the stack from exiting the container. That is, all of the boxes in the stack except for lowermost box 129 are confined within the container. Preferably, the difference in elevation between the top of front support 119 and the top of lower opening 117 is greater than the height of one of the boxes but less than twice the height of one of the boxes so that only the lowermost one of the boxes 129 can be pulled through the area of lower opening 117 above front support 119. The degree to which the difference in elevation between the top of front support 119 and the top of lower opening 117 must exceed the height of the box for enabling the box to pass through the lower opening 117 will depend on the angle to which the lowermost box 129 is pivoted about the fulcrum 119 when withdrawn from the container.

Referring now to FIG. 15, lowermost box 129 can be readily removed from the container by grasping lowermost box 129 about its front end and urging the front end downwardly as the box is pulled from the container. AS the front end of lowermost box 129 is urged downwardly, lowermost box 129 pivots about the fulcrum defined by front support 119 urging the rear end of lowermost box 129 upwardly, thereby lifting box 131 immediately above lowermost box 129 and raising all of the other boxes in the stack.

As box 131 is raised the area of frictional contact between boxes 129 and 131 is immediately reduced from the two dimensional interface A between boxes 129 and 131 to a one-dimensional line of engagement B where the upper rear edge of box 129 slides along the bottom of box 131 as box 129 will pulled from the container. The degree of friction between the boxes 129 and 131 is thereby substantially reduced for easing the withdrawal of box 129 from the container.

For transportation or storage, the magnet 116 can be readily separate from the ferromagnetic strip 112 for restoring the container to a planar sheet from which the ramp 127 and/or front and rear supports 119, 121 can be optional removed. Although the extension 110 and ferromagnetic strip 112 are shown on front panel 109 and right side panel 115, respectively, they may be provided on any adjacent edges of any two intersecting ones of the panels 109, 111, 113, 115.

It is to be appreciated that the foregoing is a description of a preferred embodiment of the invention to which alterations and modifications may be made without departing from the spirit and scope of the invention.

What is claimed is:

1. A container for facilitating removal of the lowermost box from a stack of boxes, each of said boxes having a front end and a rear end, said a container having the general form of a hollow parallelepiped and comprising
a front panel, a rear panel, a left side panel and a right side panel,
said front panel having proximate a bottom end of said container a lower opening with a width greater than the width of one of said boxes,
at least one front support mounted inside said container proximate said front panel and distal from said rear panel, upon which a bottom area of a lowermost one of said stack of boxes proximate said front end may be rested,
at least one rear support mounted inside said container proximate said rear panel and distal from said front panel, upon which a bottom area of said lowermost one of said stack of boxes proximate said rear end may be rested, one of said front support and rear support comprising a fulcrum about which said lowermost one of said stack of boxes may be rotated by lowering said front end thereby pivoting said rear end upwardly for reducing the area of contact and friction between a top surface of said lowermost one of said stack of boxes and the bottom surface of the box immediately above said lowermost one of said stack of boxes and lessening the pulling force required to withdraw said lowermost one of said stack of boxes from said stack through said opening.

2. A container according to claim 1 wherein said fulcrum comprises said front support.

3. A container according to claim 1 wherein said fulcrum comprises said rear support.

4. A container according to claim 1 wherein at least one of said front support and said rear support comprises a rod with one end mounted on said left side panel and an opposite end mounted on said right side panel.

5. A container according to claim 4 further comprising at least one roller mounted on said rod for reducing friction between said one of said front support and said rear support, and said lowermost one of said stack of boxes.

6. A container according to claim 1 further comprising a ramp mounted proximate said rear panel at an elevation high enough for urging said lowermost one of said stack of boxes in a forward direction for extending said front end of said box through said lower opening, and an elevation low enough to prevent engagement with said box immediately above said lowermost one of said stack of boxes.

7. A container according to claim 1 further comprising a magnet mounted on one of said front panel, rear panel, left side panel and right side panel and a piece of ferromagnetic material mounted on an extension of another of said front panel, rear panel, left side panel and right side panel and overlapping said magnet for removably fastening said one of said front panel, rear panel, left side panel and right side panel to said other of said front panel, rear panel, left side panel and right side panel.

8. A container according to claim 1 wherein said front support is at an elevation nearer to said bottom of said container than said rear support.

9. A container according to claim 6 wherein the uppermost end of said ramp is more distal from said bottom of said container than said rear support.

10. A container according to claim 1 wherein the distance between the top of said front support and the top of said lower opening is greater than the height of one of said boxes but less than twice the height of one of said boxes so that only said lowermost one of said boxes can be pulled through said lower opening above said front support.

11. A container according to claim 1 wherein said front support is at least 3 inches above said bottom of said container for providing sufficient clearance for pivoting the front of said lowermost box downwardly about said fulcrum.
